(19) United States
(12) Patent Application Publication
(10) Pub. No.: US 2021/0081061 A1
(43) Pub. Date: Mar. 18, 2021

(54) TOUCHPAD MODULE AND COMPUTING DEVICE USING SAME

(71) Applicant: PRIMAX ELECTRONICS LTD., Taipei City (TW)

(72) Inventor: Tai-Sou HUANG, Taipei City (TW)

(21) Appl. No.: 16/693,433

(22) Filed: Nov. 25, 2019

(30) Foreign Application Priority Data
Sep. 12, 2019 (TW) 108133059

(51) Int. Cl. G06F 3/041; G06F 1/16

(52) U.S. Cl. CPC G06F 3/041; G06F 1/1616; G06F 1/169

(57) ABSTRACT

A touchpad module includes a touch member, a bracket and a supporting assembly. The bracket is located under the touch member. The supporting assembly is arranged between a first end of the touch member and the bracket. While a second end of the touch member is swung, the supporting assembly is used as a fulcrum. The supporting assembly is slidable relative to the bracket in a leftward direction or a rightward direction. The present invention further provides a computing device with the touchpad module.

### FIELD OF THE INVENTION

The present invention relates to an input device, and more particularly to an input device with a touch control function.

### BACKGROUND OF THE INVENTION

With increasing development of science and technology, a variety of electronic devices are designed in views of convenience and user-friendliness. For helping the user well operate the electronic devices, the electronic devices are gradually developed in views of humanization. The common electronic devices include for example notebook computers, mobile phones, satellite navigation devices, or the like. Recently, the storage capacity and the processor's computing performance for these electronic devices are largely enhanced, and thus their functions become more powerful and complicated. For efficiently operating an electronic device, a touchpad is used as an input device of the electronic device for controlling the operations of the electronic device.

FIG. 1 schematically illustrates a conventional notebook computer with a touchpad module. As shown in FIG. 1, the touchpad module 1 is installed on a casing 21 of the notebook computer 2. Moreover, at least a portion of the touchpad module 1 is exposed outside so as to be touched by the user's finger. Consequently, the user may operate the touchpad module 1 to control the notebook computer 2. For example, in case that the user's finger is placed on the touchpad module 1 and slid on the touchpad module 1, a cursor 23 shown on a display screen 22 of the notebook computer 2 is correspondingly moved. Moreover, in case that the touchpad module 1 is pressed down by the user's finger, the notebook computer 2 executes a specified function. The use of the touchpad module 1 can implement some functions of the conventional mouse. In other words, the user may operate the notebook computer 2 through the touchpad module 1 without the need of additionally carrying or installing the mouse.

Please refer to FIGS. 2 and 3. FIG. 2 is a schematic cross-sectional view illustrating the touchpad module as shown in FIG. 1, in which the touchpad module is not pressed down. FIG. 3 is a schematic cross-sectional view illustrating the touchpad module as shown in FIG. 2, in which the touchpad module is pressed down. A fixing frame 24 is concavely formed in the casing 21 of the notebook computer 2. A supporting structure 241 and a triggering part 242 are respectively protruded from two opposite sides of an inner wall of the fixing frame 24. A first end 11 of the touchpad module 1 is connected with the supporting structure 241. While the touchpad module 1 is pressed down by the user, the second end 12 of the touchpad module 1 is swung downwardly relative to the triggering part 242 by using the supporting structure 241 as a fulcrum. When a switch element 13 of the touchpad module 1 is pushed by the triggering part 242, the switch element 13 is triggered to generate a switch signal to the notebook computer 2. According to the switch signal, the notebook computer 2 executes a corresponding function. When the touchpad module 1 is no longer pressed by the user, the second end 12 of the touchpad module 1 is swung upwardly relative to the triggering part 242 in response to the elastic force of the supporting structure 241. Consequently, the touchpad module 1 is returned to its original position.

As mentioned above, the conventional touchpad module is able to provide the mouse function. For example, the conventional touchpad module can provide the cursor-moving function, or the depressing action on the touchpad module can allow the notebook computer to execute the specified function. However, as the demands on the diverse operating ways of the touchpad module are gradually increased, the conventional touchpad module cannot meet the user's requirements.

Therefore, there is a need of providing an improved touchpad module in order to overcome the above drawbacks.

### SUMMARY OF THE INVENTION

An object of the present invention provides a touchpad module. The touchpad module includes a touch member and a bracket. The touch member is slidable relative to the bracket in a leftward direction or a rightward direction. Consequently, the applications of the touchpad module are expanded.

Another object of the present invention provides a computing device with the touchpad module.

In accordance with an aspect of the present invention, a touchpad module is provided. The touchpad module includes a touch member, a bracket and a supporting assembly. A switch element is installed on a bottom surface of the touch member. The bracket is located under the touch member. The supporting assembly is arranged between a first end of the touch member and the bracket. While a second end of the touch member is pressed down, the second end of the touch member is swung relative to the bracket. Consequently, the switch element on the second end of the touch member is contacted with the bracket and the switch element is triggered. The first end of the touch member is fixed on the supporting assembly. The supporting assembly is slidable relative to the bracket in a leftward direction or a rightward direction.

In accordance with another aspect of the present invention, a computing device is provided. The computing device includes a casing, a processor and a touchpad module. An accommodation space is concavely formed in the casing. The processor is disposed within the casing. The touchpad module is disposed within the accommodation space and electrically connected with the processor. The touchpad module includes a touch member, a bracket and a supporting assembly. A switch element is installed on a bottom surface of the touch member. The bracket is located under the touch member. The supporting assembly is arranged between a first end of the touch member and the bracket. While a second end of the touch member is pressed down, the second end of the touch member is swung relative to the bracket. Consequently, the switch element on the second end of the touch member is contacted with the bracket and the switch element is triggered. The first end of the touch member is fixed on the supporting assembly. The supporting assembly is slidable relative to the bracket in a leftward direction or a rightward direction.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a conventional notebook computer with a touchpad module;

FIG. 2 is a schematic cross-sectional view illustrating the touchpad module as shown in FIG. 1, in which the touchpad module is not pressed down;

FIG. 3 is a schematic cross-sectional view illustrating the touchpad module as shown in FIG. 2, in which the touchpad module is pressed down;

FIG. 4 is a schematic perspective view illustrating the outer appearance of a computing device with a touchpad module according to a first embodiment of the present invention;

FIG. 5 is a schematic top view illustrating a portion of the casing and the touchpad module of the computing device as shown in FIG. 4;

FIG. 6 is a schematic bottom view illustrating a portion of the casing and the touchpad module as shown in FIG. 5;

FIG. 7 is a schematic side view illustrating the touchpad module as shown in FIG. 5;

FIG. 8 is a schematic exploded view illustrating the casing and the touchpad module as shown in FIG. 5;

FIG. 9 is a schematic cutaway view illustrating a portion of the touchpad module as shown in FIG. 5;

FIG. 10 is a schematic top view illustrating a portion of a casing and a touchpad module of a computing device according to a second embodiment of the present invention;

FIG. 11 is a schematic bottom view illustrating a portion of the casing and the touchpad module as shown in FIG. 10;

FIG. 12 is a schematic exploded view illustrating the casing and the touchpad module as shown in FIG. 10;

FIG. 13 is a schematic perspective view illustrating the relationship between the supporting assembly and the bracket as shown in FIG. 12; and

FIG. 14 schematically illustrates a touchpad module for a computing device according to a third embodiment of the present invention.

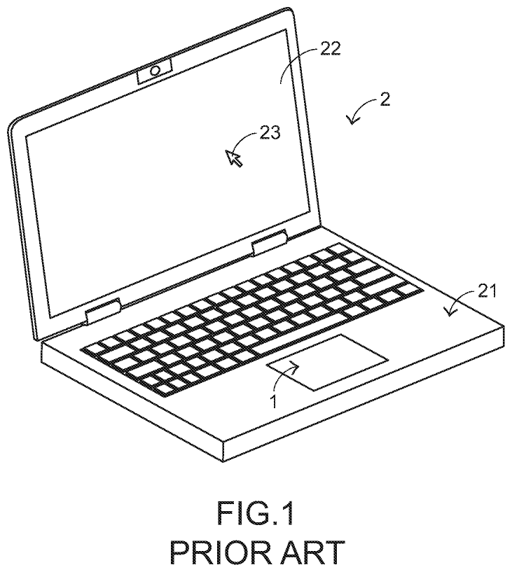

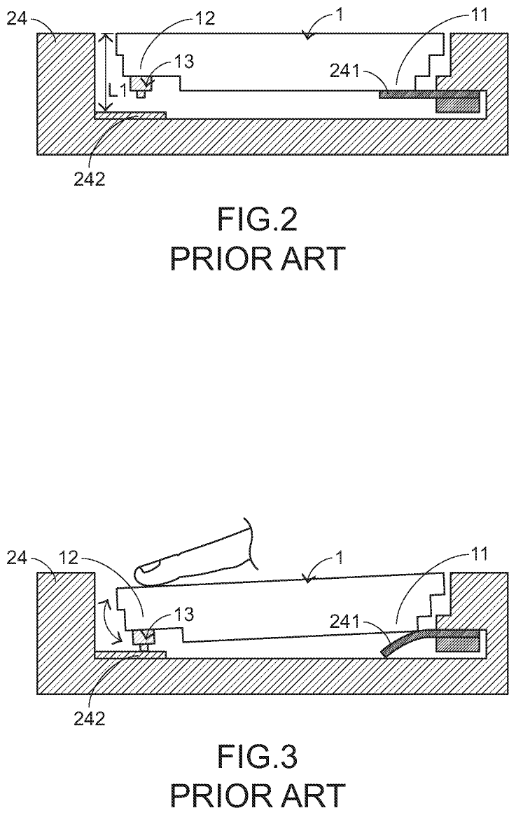

### DETAILED DESCRIPTION OF THE PREFERRED EMBODIMENT

The embodiments of present invention will be described more specifically with reference to the following drawings. Generally, in the drawings and specifications, identical or similar components are designated by identical numeral references. For well understanding the present invention, the elements shown in the drawings are not in scale with the elements of the practical product. In the following embodiments and drawings, the elements irrelevant to the concepts of the present invention or the elements well known to those skilled in the art are omitted. It is noted that numerous modifications and alterations may be made while retaining the teachings of the invention.

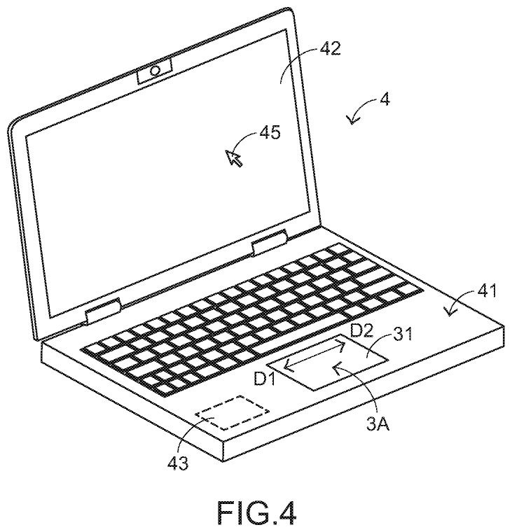

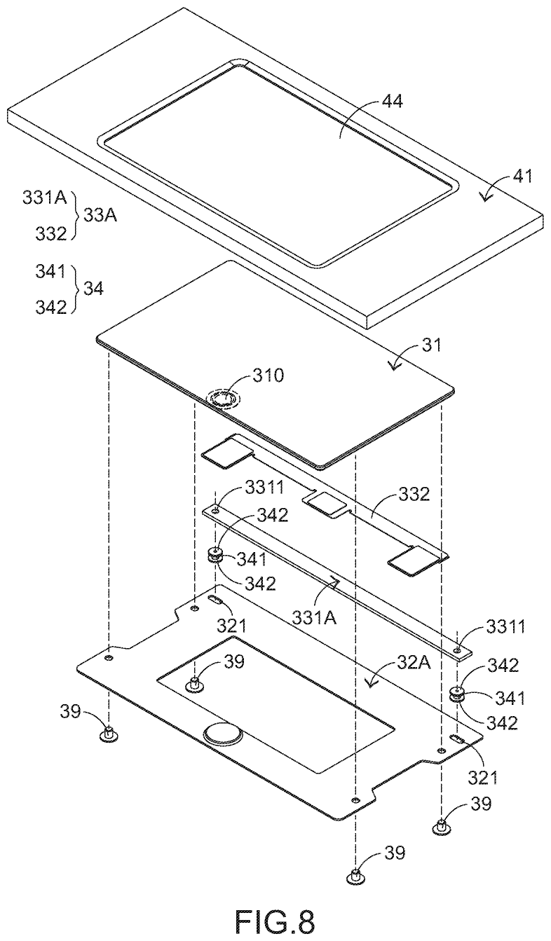

FIG. 4 is a schematic perspective view illustrating the outer appearance of a computing device with a touchpad module according to a first embodiment of the present invention. An example of the computing device 4 includes but is not limited to a notebook computer. In an embodiment, the computing device 4 comprises a casing 41, a display screen 42, a processor 43 and a touchpad module 3A. The processor 43 is disposed within the casing 41. Moreover, the processor 43 is used for processing electronic signals of the computing device 4. Moreover, an accommodation space 44 is concavely formed in the casing 41 (see FIG. 8). The touchpad module 3A is disposed within the accommodation space 44 and electrically connected with the processor 43. In addition, at least a portion of the touchpad module 3A is exposed outside so as to be touched by the user's finger. Consequently, the user may operate the touchpad module 3A to control the computing device 4. For example, in case that the user's finger is placed on the touchpad module 3A and slid on the touchpad module 3A, a cursor 45 shown on the display screen 42 is correspondingly moved. Moreover, in case that the touchpad module 3A is pressed by the user's finger, the computing device 4 executes a specified function.

Moreover, the touchpad module 3A can be moved in a first direction D1 (e.g., the leftward direction) or a second direction D2 (e.g., the rightward direction), which will be described later. When the computing device 4 senses that the touchpad module 3A is moved in the first direction D1 (e.g., the leftward direction), the computing device 4 executes a first command. When the computing device 4 senses that the touchpad module 3A is moved in the second direction D2 (e.g., the rightward direction), the computing device 4 executes a second command.

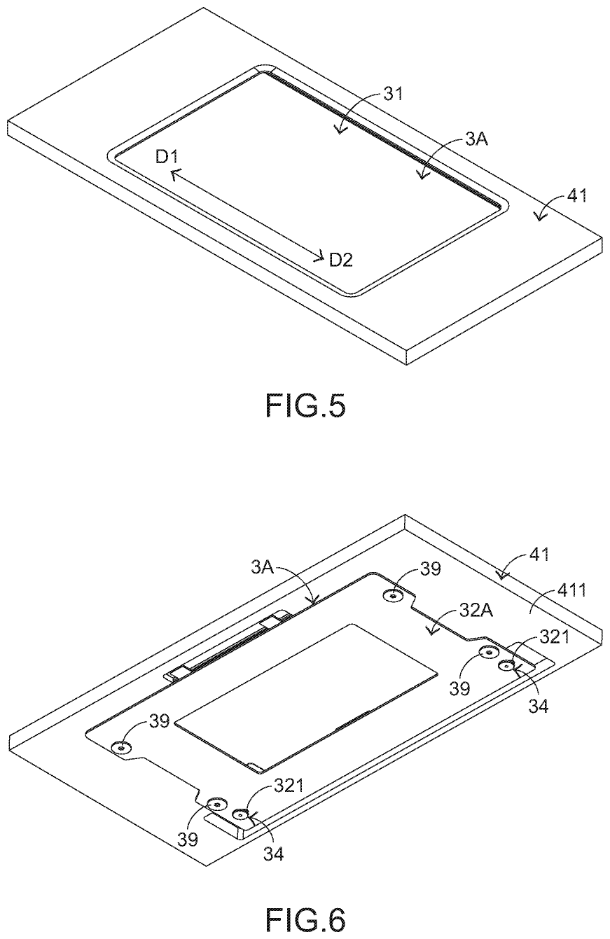

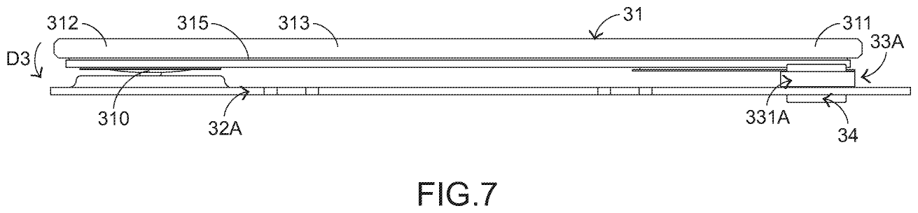

Please refer to FIGS. 5, 6 and 7. FIG. 5 is a schematic top view illustrating a portion of the casing and the touchpad module of the computing device as shown in FIG. 4. FIG. 6 is a schematic bottom view illustrating a portion of the casing and the touchpad module as shown in FIG. 5. FIG. 7 is a schematic side view illustrating the touchpad module as shown in FIG. 5. The touchpad module 3A comprises a touch member 31, a bracket 32A and a supporting assembly 33A. A switch element 310 is disposed on a bottom surface of the touch member 31. The bracket 32A is located under the touch member 31. Moreover, as shown in FIG. 6, the bracket 32A is fixed on an inner wall 411 of the casing 41 through fastening elements 39 (e.g., screws). The supporting assembly 33A is arranged between a first end 311 of the touch member 31 and the bracket 32A. While a second end 312 of the touch member 31 is swung, the supporting assembly 33A is used as a fulcrum. That is, while the second end 312 of the touch member 31 is pressed down, the second end 312 of the touch member 31 is swung relative to the bracket 32A in a third direction D3. As the second end 312 of the touch member 31 is swung, the switch element 310 on the second end 312 of the touch member 31 is contacted with the bracket 32A and thus the switch element 310 is triggered (see FIG. 7).

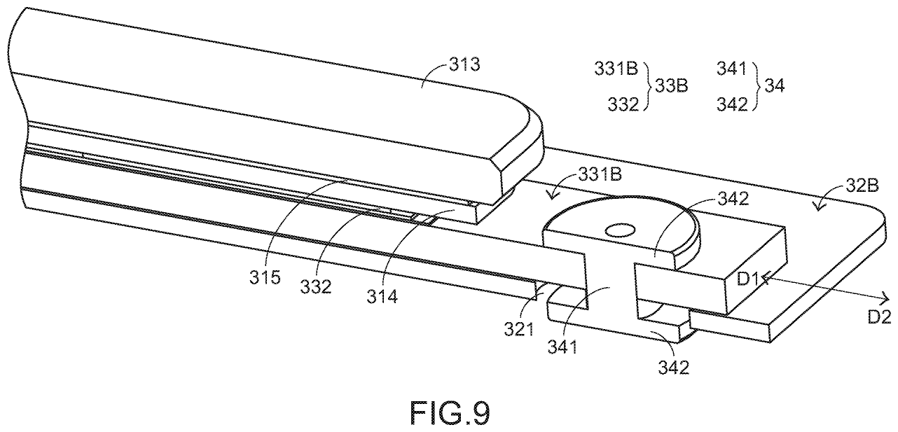

In this embodiment, the touch member 31 comprises a covering plate 313 and a circuit board 314. At least a portion of the covering plate 313 is exposed outside the casing 41. The circuit board 314 is located under the covering plate 313. The switch element 310 is installed on a bottom surface 314 of the circuit board 314. When the circuit board 314 senses the touching and operating behavior of the user on the covering plate 313, the circuit board 314 issues a corresponding electronic signal. According to the electronic signal, the computing device 4 executes a corresponding command. Preferably but not exclusively, the covering plate 313 and the circuit board 314 are combined together through an adhesive layer 315 (see FIG. 9), the covering plate 313 is a glass covering plate or a plastic covering plate, and the adhesive layer 315 is made of a pressure sensitive adhesive (PSA).

Please refer to FIGS. 8 and 9. FIG. 8 is a schematic exploded view illustrating the casing and the touchpad module as shown in FIG. 5. FIG. 9 is a schematic cutaway view illustrating a portion of the touchpad module as shown in FIG. 5. The first end 311 of the touch member 31 is fixed on the supporting assembly 33A. The supporting assembly 33A comprises a support plate 331A. The support plate 331A has perforations 3311. The bracket 32A has sliding slots 321 corresponding to the perforations 3311. In an embodiment, the touchpad module 3A further comprises connection structures 34. The connection structures 34 are penetrated through the corresponding perforations 3311 of the support plate 331A and the corresponding sliding slots 321 of the bracket 32A. Consequently, the support plate 331A and the bracket 32A are stacked on each other, and the support plate 331A is movable relative to the bracket 32A in the leftward and rightward directions. Optionally, the supporting assembly 33A further comprises an elastic element 332. The elastic element 332 is connected between the support plate 331A and the first end 311 of the touch member 31. While the second end 312 of the touch member 31 is swung relative to the bracket 32A, the elastic element 332 provides a buffering efficacy for preventing from the interference between components and the deformation of components.

In an embodiment, the connection structure 34 comprises a post body 341 and two end parts 342. The two end parts 342 are connected with two opposite sides of the post body 341, respectively. The post body 341 has a cylindrical shape. The perforation 3311 of the support plate 331A is a circular hole corresponding to the post body 341. The sliding slot 321 of the bracket 32A is an elliptic elongated hole. After the post body 341 is penetrated through the corresponding perforation 3311 of the support plate 331A and the corresponding sliding slot 321 of the bracket 32A, the post body 341 is slidable within the corresponding sliding slot 321. The two end parts 342 of the connection structure 34 are arranged beside the external side of the perforation 3311 and the external side of the sliding slot 321, respectively. Since the post body 341 is confined within the perforation 3311 and the sliding slot 321, the connection structure 34 is not detached. Preferably but not exclusively, the connection structure 34 is a rivet.

Due to the above structural design, the touchpad module 3A is movable. While the touchpad module 3A is moved in the first direction D1 (e.g., the leftward direction), the touch member 31 and the underlying supporting assembly 33A are slid relative to the bracket 32A in the first direction D1 (e.g., the leftward direction). While the touchpad module 3A is moved in the second direction D2 (e.g., the rightward direction), the touch member 31 and the underlying supporting assembly 33A are slid relative to the bracket 32A in the second direction D2 (e.g., the rightward direction). Consequently, the applications of the touchpad module 3A are expanded.

In the above embodiment, the perforations 3311 are formed in the support plate 331A, and the sliding slots 321 are formed in the bracket 32A. It is noted that numerous modifications and alterations may be made while retaining the teachings of the invention. For example, in another embodiment, the perforations are formed in the bracket, and the sliding slots are formed in the support plate 331A.

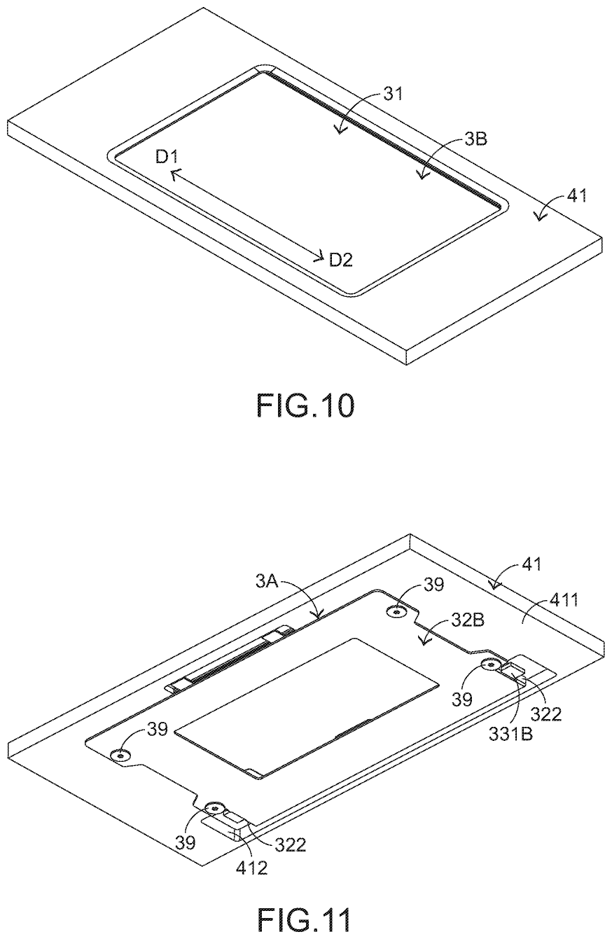

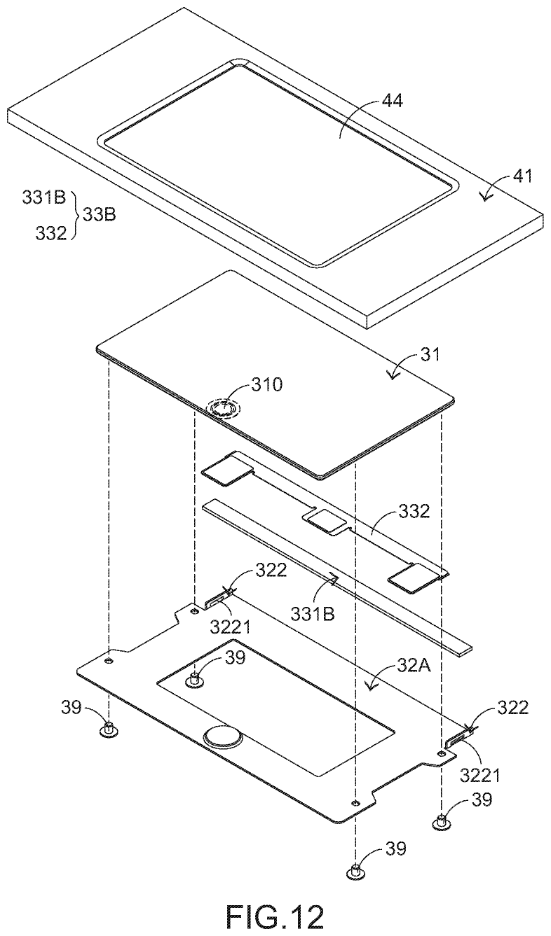

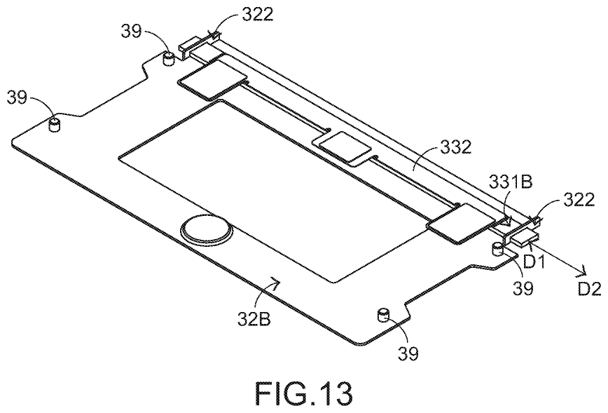

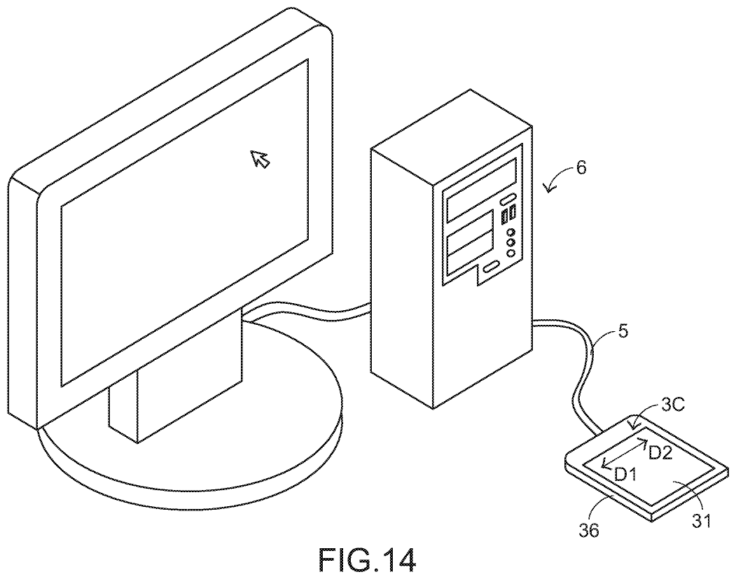

Please refer to FIGS. 10, 11, 12 and 13. FIG. 10 is a schematic top view illustrating a portion of a casing and a touchpad module of a computing device according to a second embodiment of the present invention. FIG. 11 is a schematic bottom view illustrating a portion of the casing and the touchpad module as shown in FIG. 10. FIG. 12 is a schematic exploded view illustrating the casing and the touchpad module as shown in FIG. 10. FIG. 13 is a schematic perspective view illustrating the relationship between the supporting assembly and the bracket as shown in FIG. 12. The structures and functions of the components of the computing device 4 and the touchpad module 3B which are identical to those of the first embodiment are not redundantly described herein. In comparison with the first embodiment, the touchpad module 3B is not equipped with the connection structures 34, the support plate 331B is not equipped with the perforations, and the bracket 32B is not equipped with the sliding slots. Moreover, the bracket 32B comprises two protrusion structures 322. The two protrusion structures 322 are upwardly protruded from two lateral edges of the bracket 32B, respectively. Moreover, each protrusion structure 322 has an opening 3221.

For assembling the supporting assembly 33B with the bracket 32B, the two ends of the support plate 331B are penetrated through the two openings 3221 of the bracket 32B, respectively. Consequently, the support plate 331B can be slid relative to the bracket 32B in the leftward direction or the rightward direction. Optionally, while the support plate 331B is slid in the leftward direction or the rightward direction, the inner wall 412 of the casing 41 provides the function of stopping the support plate 331B (see FIG. 11).

Due to the above structural design, the touchpad module 3B is movable. While the touchpad module 3B is moved in the first direction D1 (e.g., the leftward direction), the touch member 31 and the underlying supporting assembly 33B are slid relative to the bracket 32B in the first direction D1 (e.g., the leftward direction). While the touchpad module 3B is moved in the second direction D2 (e.g., the rightward direction), the touch member 31 and the underlying supporting assembly 33B are slid relative to the bracket 32B in the second direction D2 (e.g., the rightward direction). Consequently, the applications of the touchpad module 3B are expanded.

In the above embodiments, the touchpad modules 3A and 3B are installed in the computing device 4. In some other embodiments, the touchpad module 3A or 3B is not installed in the computing device 4. FIG. 14 schematically illustrates a touchpad module for a computing device according to a third embodiment of the present invention. As shown in FIG. 14, the touchpad module 3C is an external input device that is independent from the computing device. The touchpad module 3C is in communication with a desktop computer 6 through a signal transmission means 5. For example, the signal transmission means 5 is a universal serial bus (USB). The components of the touchpad module 3C are similar to the components of the touchpad module 3A of the first embodiment or the components of the touchpad module 3B of the second embodiment. In contrast, the touchpad module 3C of this embodiment further comprises a standalone casing 36 for accommodating the touch member 31, the supporting assembly 33A/33B and the bracket 32A/32B.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A touchpad module, comprising:
a touch member, wherein a switch element is installed on a bottom surface of the touch member;
a bracket located under the touch member; and
a supporting assembly arranged between a first end of the touch member and the bracket, wherein while a second end of the touch member is pressed down, the second end of the touch member is swung relative to the bracket, so that the switch element on the second end of the touch member is contacted with the bracket and the switch element is triggered,
wherein the first end of the touch member is fixed on the supporting assembly, and the supporting assembly is slidable relative to the bracket in a leftward direction or a rightward direction.

2. The touchpad module according to claim 1, wherein one of the supporting assembly and the bracket comprises a perforation, and the other of the supporting assembly and the bracket comprises a sliding slot, wherein a connection structure is penetrated through the perforation and the sliding slot, so that the supporting assembly is slidable relative to the bracket in the leftward direction or the rightward direction.

3. The touchpad module according to claim 2, wherein the touchpad module further comprises the connection structure, and the connection structure comprises a post body and two end parts, wherein the post body is penetrated through the perforation and the sliding slot, and the two end parts are respectively connected with two opposite sides of the post body, so that the post body is confined within the perforation and the sliding slot.

4. The touchpad module according to claim 3, wherein the post body has a cylindrical shape, the perforation is a circular hole corresponding to the post body, and the sliding slot is an elliptic elongated hole, so that the post body is slidable within the corresponding sliding slot.

5. The touchpad module according to claim 2, wherein the supporting assembly comprises a support plate, and the support plate has the perforation or the sliding slot.

6. The touchpad module according to claim 5, wherein the supporting assembly further comprises an elastic element, and the elastic element is connected between the support plate and the first end of the touch member.

7. The touchpad module according to claim 1, wherein the bracket comprises two protrusion structures, and the two protrusion structures are upwardly protruded from two lateral edges of the bracket, respectively, wherein the two protrusion structures comprise two openings, respectively.

8. The touchpad module according to claim 7, wherein the supporting assembly comprises a support plate, and two ends of the support plate are penetrated through the corresponding openings of the protrusion structures, so that the supporting assembly is slidable relative to the bracket in the leftward direction or the rightward direction.

9. The touchpad module according to claim 8, wherein the supporting assembly further comprises an elastic element, and the elastic element is connected between the support plate and the first end of the touch member.

10. The touchpad module according to claim 1, wherein the touchpad module further comprises a covering plate and a circuit board, wherein the covering plate is located over the circuit board, a portion of the covering plate is exposed outside a casing, and the switch element is installed on a bottom surface of the circuit board.

11. The touchpad module according to claim 10, wherein the covering plate is a glass covering plate or a plastic covering plate, and the covering plate and the circuit board are combined together through an adhesive layer.

12. The touchpad module according to claim 11, wherein the casing is included in a computing device, or the touchpad module contains the casing.

13. A computing device, comprising:
a casing, wherein an accommodation space is concavely formed in the casing;
a processor disposed within the casing; and
a touchpad module disposed within the accommodation space and electrically connected with the processor, wherein the touchpad module comprises:
a touch member, wherein at least a portion of the touch member is exposed outside, and a switch element is installed on a bottom surface of the touch member;
a bracket located under the touch member; and
a supporting assembly arranged between a first end of the touch member and the bracket, wherein while a second end of the touch member is pressed down, the second end of the touch member is swung relative to the bracket, so that the switch element on the second end of the touch member is contacted with the bracket and the switch element is triggered,
wherein the first end of the touch member is fixed on the supporting assembly, and the supporting assembly is permitted to be slid relative to the bracket in a leftward direction or a rightward direction.

14. The computing device according to claim 13, wherein when the touch member is slid relative to the supporting assembly in the leftward direction, the computing device executes a first command, wherein when the touch member is slid relative to the supporting assembly in the rightward direction, the computing device executes a second command.

15. The computing device according to claim 13, wherein one of the supporting assembly and the bracket comprises a perforation, and the other of the supporting assembly and the bracket comprises a sliding slot, wherein a connection structure is penetrated through the perforation and the sliding slot, so that the supporting assembly is slidable relative to the bracket in the leftward direction or the rightward direction.

16. The computing device according to claim 15, wherein the touchpad module further comprises the connection structure, and the connection structure comprises a post body and two end parts, wherein the post body is penetrated through the perforation and the sliding slot, and the two end parts are respectively connected with two opposite sides of the post body, so that the post body is confined within the perforation and the sliding slot.

17. The computing device according to claim 16, wherein the post body has a cylindrical shape, the perforation is a circular hole corresponding to the post body, and the sliding slot is an elliptic elongated hole, so that the post body is slidable within the corresponding sliding slot.

18. The computing device according to claim 13, wherein the bracket comprises two protrusion structures, and the two protrusion structures are upwardly protruded from two lateral edges of the bracket, respectively, wherein the two protrusion structures comprise two openings, respectively, and two ends of the support plate are penetrated through the corresponding openings of the protrusion structures, so that the supporting assembly is slidable relative to the bracket in the leftward direction or the rightward direction.

19. The computing device according to claim 13, wherein the touchpad module further comprises a covering plate and a circuit board, wherein the covering plate is located over the circuit board, a portion of the covering plate is exposed outside the casing, and the switch element is installed on a bottom surface of the circuit board

20. The computing device according to claim 19, wherein the covering plate is a glass covering plate or a plastic covering plate, and the covering plate and the circuit board are combined together through an adhesive layer.
